(19) United States
(12) Patent Application Publication
(10) Pub. No.: US 2004/0150545 A1
(43) Pub. Date: Aug. 5, 2004

(54) Coding method

(76) Inventors: Raymond Gass, Bolsenheim (FR); Michel Le Creff, Vigny (FR)

Correspondence Address: Sughrue Mion, Suite 800, 2100 Pennsylvania Avenue NW, Washington, DC, 20037-3213, US

(21) Appl. No.: 10/478,856

(22) PCT Filed: May 30, 2002
(86) PCT No.: PCT/FR02/01821

(30) Foreign Application Priority Data
May 31, 2001 (FR) 01/07157

(51) Int. Cl. H04L 17/02

(52) U.S. Cl. 341/173

(57) ABSTRACT

The method consists in coding a binary word in accordance with a plurality of coding tables, the coding table for each binary word to be coded being chosen as a function of at least one supplementary information item to be coded. In a first variant, a word of p bits is coded with a symbol made up of q ternary digits, p and q being chosen so that the number of symbols having a weight equal to 0 is at least equal to 2×2^{p}. A first coding table contains 2^{p} symbols having a weight equal to 0. A second coding table contains 2^{p}other symbols having a weight equal to 0. In a second variant, p and q are chosen so that the number of symbols having a weight equal to 0 or a weight equal to ±1 is at least equal to 3×2^{p}; a first coding table contains 2^{p} symbols having a weight equal to 0; a second coding table contains 2^{p} other symbols having a weight equal to −1; and a third coding table contains 2^{p} other symbols having a weight equal to +1. In a third variant, q binary symbols are used; p and q are chosen so that q is greater than or equal to p+1; a first coding table contains 2^{p} symbols; and a second coding table contains 2^{p} other symbols.

Application in particular to data transmission networks conforming to the IEEE 802.3 standard.

The invention relates to a coding method that can be used in particular in data transmission networks conforming to the IEEE 802.3 standard.

The object of the invention is to code data to enable transmission of the data over a line at the same time as transmitting supplementary information items such as a start of byte indication or a start of frame indication, or an information item relating to error detection and where applicable error correction. Indicating the start of a data frame by coding it with a combination of symbols having a low probability of being imitated by the payload data is known in the art; detecting errors in a frame by coding and transmitting a cyclic redundancy check word calculated as a function of the data transmitted in that data frame is also known in the art. These supplementary information items increase the volume of symbols transmitted.

Obtaining a line bit rate lower than the bit rate of the binary data to be transmitted by coding a binary word of p bits with a symbol consisting of a ternary word made up of q ternary digits (i.e. having a weight equal to −1 or 0 or +1), is known in the art and is referred to as pB/qT coding or a pB/qT code. This ternary coding was introduced with the aim of reducing the modulation rate, but further avoids the transmission of a direct current on a metal line, provided that, over a long time interval, the same number of symbols of weight +1 and symbols of weight −1 are sent. The absence of direct current is important for transmission over a metal line because a metal line is isolated at each end by a respective transformer and the transformers could become saturated if there were a direct current.

In the codes used at present (4B/3T, 8B/6T), the number of ternary symbols having a weight equal to 0 is less than the number of binary words to be coded. Coding certain binary words by means of two different symbols for the same binary word, one ternary word of weight +1 and one ternary word of weight −1, to prevent a direct current, is known in the art. The sum of the weights of the symbols transmitted is calculated continuously, and coding consists in using the symbol of weight +1 if the current value of the sum is equal to −1 and using the symbol of weight −1 if the current value of the sum is equal to +1. Ternary coding methods known in the art therefore transmit all the values of a binary word of four bits or eight bits, with no direct current, but hove two drawbacks:

The number of symbols available is insufficient for transmitting supplementary information items.

The redundancy of certain symbols, which is used to eliminate the direct current, reduces the number of unused symbols, and therefore reduces the efficiency of transmission error detection.

Another problem arises: if a long series of zeros is transmitted, the receiver device may become desynchronized. The document EP 0.548.41 5A describes a coding method consisting in coding a bit of a main binary signal using a ternary symbol. The coding is of the alternate mark inversion (AMI) type to prevent a direct current. To prevent the transmission of long series of zeros, this prior art method changes the coding law if a long series of zeros could be sent. The coding laws used are similar to those of the HDB3 code standardized by the CCITT, but long series of zeros are replaced by a method differing from that used in the HDB3 code.

The transmission of a symbol coding one bit of the main binary signal is then replaced by the transmission of a symbol violating the coding law being used. This violation of the current coding law signifies that the coding table has been changed. As it is nevertheless necessary to transmit the bit that has been eliminated, and it is desirable not to increase the bit rate of the symbols transmitted, the method consists in coding that bit using a new coding law which is chosen as a function of the value of that bit. On reception, this bit is decoded by identifying which is the new coding law. Thus the change, of coding law neither reduces the number of bits transmitted nor increases the transmission bit rate.

The object of the present invention is to propose a coding method that does not necessitate the replacement of long series of zeros and which transmits supplementary bits efficiently for a given transmission bit rate.

In a first variant, the invention consists in a coding method consisting in coding a word of p bits with a symbol made up of q ternary digits in accordance with a plurality of coding tables, a coding table being chosen for each binary word to be coded as a function of at least one information item to be coded;

characterized in that p and q are chosen so that the number of symbols having a weight equal to 0 is at least equal to 2×2^{p};

in that a first coding table contains 2^{p} symbols having a weight equal to 0; and

in that a second coding table contains 2^{p} other symbols having a weight equal to 0.

The method characterized as above codes each of the 2^{p} binary words constituting the data to be transmitted with two different symbols having a weight equal to 0 and additionally codes a supplementary information item by changing the coding table. The absence of direct current is then achieved without having to monitor the sum of the weights of the symbols transmitted, which simplifies the production of a coder and a decoder.

In a second variant, the invention consists in a coding method consisting in coding a word of p bits with a symbol made up of q ternary digits in accordance with a plurality of coding tables, a coding table being chosen for each binary word to be coded as a function of at least one information item to be coded;

characterized in that p and q are chosen so that the number of symbols having a weight equal to 0 or a weight equal to ±1 is at least equal to 3×2^{p};

in that a first coding table contains 2^{p} symbols having a weight equal to 0;

in that a second coding table contains 2^{p} other symbols having a weight equal to −1; and

in that a third coding table contains 2^{p} other symbols having a weight equal to +1.

The method characterized as above codes each of the 2^{p} binary words constituting the data to be transmitted with three different symbols (one having a weight equal to 0, one having a weight equal to +1, and one having a weight equal to −1). It can therefore code three supplementary information items by changing the coding table. In the case of a metal line, since the symbols used do not all have a weight equal to 0, it is necessary to maintain a zero direct current. A preferred embodiment then consists in alternating coding in accordance with the second table and coding in accordance with the third table as a function of the current value of the sum of the weights of the symbols previously coded and transmitted:

If the sum is equal to +1, a table that codes all the binary words with only symbols of weight equal to −1 is used.

If the sum is equal to −1, a table that codes all the binary words with only symbols of weight equal to +1 is used.

If the sum is equal to 0, a table that codes all the binary words with only symbols of weight equal to 0 is used.

If the above rule is not respected in the received data, this means that a transmission error has occurred. This coding achieves good error detection.

In a third variant, particularly suitable for a non-metal line, such as an optical fiber line, the method consists in a coding method consisting in coding a word of p bits with a symbol made up of q binary digits in accordance with a plurality of coding tables, a coding table being chosen for each binary word to be coded as a function of at least one information item to be coded;

characterized in that p and q are chosen so that q is greater than or equal to p+1 and in that a first coding table contains 2^{p} symbols and a second coding table contains 2^{p} other symbols.

The method characterized as above codes, with two different symbols, each of the 2^{p} binary words constituting the data to be transmitted, and additionally codes a supplementary information item by changing the coding table. The three variants of the method according to the invention avoid replacing long series of zeros since they achieve sufficient symbol redundancy to construct coding tables such that there are never long series of zeros. It is then possible to use a change of table to code any supplementary information item, totally independently of the method of preventing long series of zeros. In fact, the method according to the invention codes each of the binary words constituting the data to be transmitted with at least two different symbols. As each binary word can be represented by at least two chosen symbols, it is possible to transmit a supplementary information item represented by the chosen symbol, i.e. the chosen coding table. The supplementary information item is reproduced as a function of the decoding table used to decode a binary word.

One use of the supplementary information item is to discriminate frames belonging to a virtual network reserved for the transmission of data and frames belonging to a virtual network reserved for telephone transmission, depending on the coding table used. This discrimination means that the two types of frame can be processed with two different priority levels. Obtaining this information item without having to analyze the content of the frames to extract a priority code shortens the time taken to process the frames.

Another application of these supplementary information items is to detect the start of a message or the start of a byte by a change of coding table. For example, identifying a frame start is faster by detecting a change of coding table than by detecting a preamble and a frame delimiter, as in conventional methods.

If the number of symbols, which is 2^{q}, is greater than twice the number of binary words to be coded, which is 2^{p}, it is possible to transmit specific symbols for certain service information items, such as the start delimiter of a message.

Certain symbols that are not used also contribute to error detection since the detection, after the synchronization phase, of a symbol that is not used indicates an error.

In a preferred embodiment, the coding method consists in changing coding table to indicate the start of a message and further consists in indicating the start of the message by a symbol that cannot be imitated by a combination of two successive symbols from among those used in the coding tables.

Another application of the supplementary information items transmitted consists in locating information items for managing an Ethernet link. In fact, on Ethernet links, transmission starts with a phase of negotiating characteristics and capacities of the end equipment, followed by a learning phase. During the learning phase, the equipment starts by sending sequences of relatively long bursts of bits; these are bursts of clock pulses, spaced by 125±14 microseconds. Seventeen pulses of odd rank are always present and constitute only a clock signal. Sixteen pulses of even rank constitute data: a pulse of even rank represents a 1 and an absence of a pulse of even rank represents a 0. In other words, ternary coding is used to reduce the bit rate, but in certain cases the binary words are twice as long in order for them to be recognized correctly.

The decoding operation is fairly complex: it is necessary to analyze the whole of the sequence of bursts, with the relevant temporal constraints. Timers verify that a clock pulse lasts 125 microseconds, that a data pulse lasts 62.5 microseconds, and that the interval between two data pulses lasts at least 31.25 microseconds for a pulse of value 1 and 93.75 microseconds for a pulse of value 0. Thanks to the coding method according to the invention, these transactions can be marked by the change of coding table. The decoding operation is then greatly simplified.

If the number of symbols, which is 2^{q}, is greater than twice the number of binary words to be coded, it is possible to transmit specific symbols for certain service information items, such as the start delimiter of a message.

Certain symbols that are not used also contribute to error detection since the detection of a symbol that is not used indicates an error.

The invention also consists in a coder and a decoder for implementing the method according to the invention.

The invention will be better understood and other features will become apparent in the light of the description of embodiments of the invention:

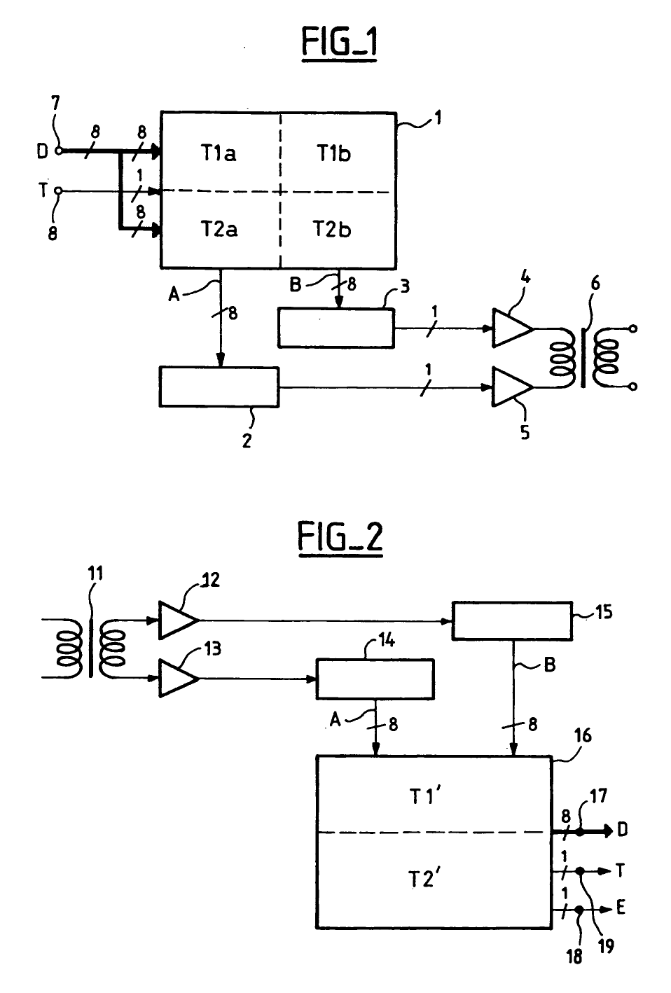

FIG. 1 represents the block schematic of one example of a coder for one embodiment of the method according to the invention on a metal line.

FIG. 2 represents the block schematic of one example of a decoder for this embodiment of the method according to the invention on a metal line.

The table below illustrates a very simple example in which p=4 and q=4. This coding example codes 16 binary words of 4 bits by means of symbols including 4 ternary numbers. These symbols are classified horizontally by increasing weight, from the weight −4 to the weight +4. There are 81 symbols, of which 19 have a value of 0, 31 have a value from +1 to +4, and 31 have a value from −1 to −4. It is to be noted that sixteen symbols have a weight equal to +1 and sixteen symbols have a weight equal to −1.

| −4 | −3 | −2 | −1 | 0 | 1 | 2 | 3 | 4 |
|---|---|---|---|---|---|---|---|---|
| −−−− | 0−−− | 00−− | 000− | 0000 | 000+ | 00++ | 0+++ | ++++ |
| | −0−− | 0−0− | 00−0 | 00+− | 00+0 | 0+0+ | +0++ | |
| | −−0− | 0−−0 | 0+−− | 00−+ | 0−++ | 0++0 | ++0+ | |
| | −−−0 | −00− | 0−00 | 0+0− | 0+00 | +00+ | +++0 | |
| | | −0−0 | 0−+− | 0+−0 | 0+−+ | +0+0 | | |
| | | −−00 | 0−−+ | 0−0+ | 0++− | ++00 | | |
| | | −−−+ | +0−− | 0−+0 | −0++ | +++− | | |
| | | −−+− | +−0− | +0−0 | −+0+ | ++−+ | | |
| | | −+−− | +−−0 | +00− | −++0 | +−++ | | |
| | | +−−− | −000 | ++−− | +000 | −+++ | | |
| | | | −0+− | +−00 | −0−+ | | | |
| | | | −0−+ | +−−+ | +0+− | | | |
| | | | −+0− | +−+− | +−0+ | | | |
| | | | −+−0 | −00+ | +−+0 | | | |
| | | | −−0+ | −0+0 | ++0− | | | |
| | | | −−+0 | −+00 | ++−0 | | | |
| | | | | −+−+ | | | | |
| | | | | −++− | | | | |
| | | | | −−++ | | | | |

A first coding table is constructed by coding the sixteen binary words 0000, 0001, . . . , 1111 by means of sixteen symbols of weight equal to 0. Two symbols of weight equal to 0 remain available for supplementary information items, the symbol 0000 not being used because it complicates the recovery of a clock signal on receiving coded data.

A second coding table is constructed by coding the sixteen binary words 0000, 0001, . . . , 1111 by means of sixteen symbols of weight +1.

A third coding table is constructed by coding the sixteen binary words 0000, 0001, . . . , 1111 by means of sixteen symbols of weight −1.

It is possible to detect transmission errors by detecting all illegal ternary words, i.e. all those of weight −2, −3, −4, +2, +3, +4. It is possible to code a supplementary information item by a change of coding table. For example, the start of a message is detected by detecting a change from the first table to the second or third table.

Since the symbols used do not all have a weight equal to 0, it is necessary to maintain a zero direct current. One example of this is the following:

If the sum is equal to +1, the third table is used, the latter coding all the binary words with only symbols with a weight equal to −1.

If the sum is equal to −1, the second table is used, the latter coding all the binary words with only symbols with a weight equal to +1.

If the sum is equal to 0, and if there is no start of message to be indicated, a table is used that codes all the binary words with only symbols of weight equal to 0.

If a received symbol violates the above rule, this means that it is affected by a transmission error.

A second example consists in coding 256 binary words of 8 bits by means of symbols including eight ternary numbers (8B/8T coding). The number of symbols of weight equal to 0 is equal to 744. A first coding table is constructed by coding the 256 binary words 00000000, . . . , 11111111 by means of 256 symbols of weight equal to 0.

A second coding table is constructed by coding the 256 binary words by means of 256 other symbols of weight equal to 0. The change from the first to the second coding table codes a supplementary information item such as the change from one type of data to another (for example voice/data).

This type of coding allows fast decoding since there is no need to extract and then recognize a symbol; it is sufficient to recognize the change of table at the time of decoding. Decoding uses two decoding tables simultaneously. The table by means of which the received symbol is recognized supplies the decoded binary word and a supplementary bit that identifies the table.

A third coding table can be constructed to code 231 supplementary information items (such as a start of message indicator symbol, an end of message indicator symbol, error control codes, etc) by means of 231 other symbols of weight equal to 0.

A preferred embodiment consists in changing coding table to indicate the start of a message and further consists in indicating the start of the message by a symbol that cannot be imitated by a combination of two successive symbols from those used in the coding tables. That symbol is −−−−++++, for example.

FIG. 1 represents the block schematic of one example of a coder for this embodiment (8B/8T) of the method according to the invention on a metal line.

It includes:

a memory 1 containing two coding tables T1 and T2 and having:

an input 8 for selecting a table, this input receiving a binary signal T that represents a binary information item to be transmitted (for example to indicate the start of a frame),

an address input 7 common to both tables T1 and T2, this input receiving a binary word D that constitutes a data byte to be coded; and

an output supplying sixteen bits, in the form of a word A of eight bits and a word B of eight bits;

two registers 2 and 3 each having eight parallel inputs and one serial output, eight bits at the output of the memory 1 being fed to the inputs of the register 2 and the other eight bits being fed to the inputs of the register 3;

two line amplifiers 4 and 5 each having an input connected to an output of one of the registers 2 and 3; and

a line transformer 6 having a primary winding connected to the outputs of the two line amplifiers 4 and 5 and a secondary winding connected to a two-wire transmission line, not shown.

Control means, not shown, control the registers 2 and 3 in synchronism with the memory 1.

The output of each of the amplifiers 4 and 5 can only have a high state or a low state, that state being controlled by a binary signal applied to its input. A ternary digit of value +1 is sent by setting the output of the amplifier 4 to a high level and the output of the amplifier 5 to a low level. A ternary digit of value −1 is sent by setting the output of the amplifier 4 to a low level and the output of the amplifier 5 to a high level. A ternary digit of value 0 is sent by setting the output of the amplifier 4 to a high level and the output of the amplifier 5 to a high level, for example.

For example, if the table T1 is used, its portion T1a supplies the bits activating the amplifier 5 and its portion T1b supplies the bits activating the amplifier 4. To code a symbol, it is necessary to activate the amplifier 5 with eight successive bits, namely the eight bits constituting the word A. In parallel with this, it is necessary to activate the amplifier 4 with eight other successive bits, namely the eight bits constituting the word B. The memory 1 supplies these sixteen bits (word A and word B) at the same time to the shift registers 2 and 3. The function of these registers is to reproduce these bits sequentially at eight successive times.

For example, to send the symbol S=00+0−−++, the memory 1 supplies simultaneously the following words A and B (word A=column A; word B=column B):

| S | A | B |
|---|---|---|
| 0 | 0 | 0 |
| 0 | 0 | 0 |
| + | 1 | 0 |
| 0 | 0 | 0 |
| − | 0 | 1 |
| − | 0 | 1 |
| + | 1 | 0 |
| + | 1 | 0 |

The register 2 stores in parallel the content A of the second column in the above table. The register 3 stores in parallel the content B of the third column of the above table. For each symbol, the registers 2 and 3 are read eight times in order for each of them to output eight successive bits in series.

FIG. 2 represents the block schematic of one example of a decoder for this embodiment (8B/8T) of the method according to the invention, on a metal line. It includes:

a line transformer 11 having a primary winding connected to a two-wire line, not shown, and a secondary winding;

two line receivers 12 and 13 each having an input connected to the secondary winding of the transformer 11;

two registers 14 and 15 having a serial input and eight parallel outputs; and

a memory 16 containing two decoding tables T1′ and T2′, this memory having:

an address input receiving eight bits supplied by the outputs of the register 14 (word A) and eight bits supplied by the outputs of the register 15 (word B);

an output 17 supplying a binary word D of eight bits that constitutes a decoded data byte;

an output 18 supplying a bit T reproducing a supplementary binary information item (for example a start of frame indication); and

an output 19 supplying a bit E indicating, where applicable, that the received symbol does not correspond to any of the expected symbols and is therefore erroneous.

Control means, not shown, control the registers 14 and 15 in synchronism with the memory 16.

The output of each of the amplifiers 12 and 13 can have only a high state or a low state, respectively representing the values 0 and 1. The reception of a ternary digit of value +1 is reflected in a 1 value at the output of the amplifier 12 and a 0 value at the output of the amplifier 13. The reception of a ternary digit of value −1 is reflected in a 0 value at the output of the amplifier 12 and a 1 value at the output of the amplifier 13. The reception of a ternary digit of value 0 is reflected in a 0 value at the output of the amplifier 12 and a 0 value at the output of the amplifier 14, for example.

Each received ternary digit is therefore represented by a pair of bits. The register 14 stores the first bit of each pair. The register 15 stores the second bit of each pair. The registers 14 and 15 are commanded eight times for each symbol so that each stores eight successive bits. The two bits of each pair are recorded by the registers 14 and 15 simultaneously.

The decoding of a symbol S consisting of eight ternary digits to a binary word D of eight bits is carried out in two steps:

In a first step, eight pairs of bits that correspond to eight respective ternary digits constituting a received symbol are stored successively in the registers 14 and 15.

In a second step, the parallel outputs of the registers 14 and 15 simultaneously supply these eight pairs of bits to the address input of the memory 16, in the form of a binary word A of eight bits and a binary word B of eight bits. For example, if the symbol S=00+0−−++has been received, they supply simultaneously the following eight pairs of bits (columns A and B):

| S | A | B |
|---|---|---|
| 0 | 0 | 0 |
| 0 | 0 | 0 |
| + | 1 | 0 |
| 0 | 0 | 0 |
| − | 0 | 1 |
| − | 0 | 1 |
| + | 1 | 0 |
| + | 1 | 0 |

The sixteen bits 11100011, 00001100 applied to the address input of the memory 16 cause the reading therein of a binary word of nine bits, unless the received symbol is erroneous. Of these nine bits, eight constitute a decoded data binary word D and the ninth bit T indicates if the received symbol belongs to the coding table T1′ or the decoding table T2′.

A value of q lower than the value of p must be chosen to reduce the modulation rate and therefore the bit rate on the line.

A third example, satisfying this condition, consists in coding 65536 binary words of 16 bits by means of symbols including twelve ternary digits (16B/12T coding). The number of symbols of weight equal to 0 is greater than twice 65536. A first coding table is constructed by coding the 65536 binary words by means of 65536 symbols of weight equal to 0. A second coding table is constructed by coding the 65536 binary words by means of 65536 other symbols of weight equal to 0. The change from the first coding table to the second codes a supplementary information item.

The implementation of a coder and a decoder for this type of coding is analogous to that previously described.

A fourth example, which is suitable for an optical transmission line, consists in coding 256 binary words of 8 bits by means of symbols including 10 bits (8B/10B coding). The number of symbols is 1024. A first coding table is constructed by coding the 256 binary words by means of 256 first symbols. A second coding table is constructed by coding the 256 binary words by means of 256 second symbols. There remain 512 unused symbols that help to facilitate error detection. The change from the first coding table to the second codes a supplementary information item.

The implementation of a coder and a decoder for this type of coding is analogous to that previously described.

1. A coding method consisting in coding a word of p bits with a symbol made up of q ternary digits in accordance with a plurality of coding tables, a coding table being chosen for each binary word to be coded as a function of at least one information item to be coded;
characterized in that p and q are chosen so that the number of symbols having a weight equal to 0 is at least equal to 2×2^{p};
in that a first coding table contains 2^{p} symbols having a weight equal to 0; and
in that a second coding table contains 2^{p} other symbols having a weight equal to 0.

2. A coding method consisting in coding a word of p bits with a symbol made up of q ternary digits in accordance with a plurality of coding tables, a coding table being chosen for each binary word to be coded as a function of at least one information item to be coded;
characterized in that p and q are chosen so that the number of symbols having a weight equal to 0 or a weight equal to ±1 is at least equal to 3×2^{p};
in that a first coding table contains 2^{p} symbols having a weight equal to 0;
in that a second coding table contains 2^{p} other symbols having a weight equal to −1; and
in that a third coding table contains 2^{p} other symbols having a weight equal to +1.

3. A coding method consisting in coding a word of p bits with a symbol made up of q binary digits in accordance with a plurality of coding tables, a coding table being chosen for each binary word to be coded as a function of at least one information item to be coded;
characterized in that p and q are chosen so that q is greater than or equal to p+1 and in that a first coding table contains 2^{p} symbols and a second coding table contains 2^{p} other symbols.

4. A method according to any one of claims 1 to 3, characterized in that it consists in changing coding table to indicate the start of a message and further consists in indicating the start of the message by a symbol that cannot be imitated by a combination of two successive symbols from those used in the coding tables.

5. A method according to claim 2, characterized in that it further consists in alternating coding in accordance with the second table and in accordance with the third table as a function of the current value of the sum of the weights of symbols previously coded and transmitted.

6. A method according to either claim 1 or claim 2, characterized in that p=16 and q=12.

7. A method according to claim 3, characterized in that p=8 and q=10.

8. A coder for coding a word of p bits with a symbol made up of q ternary digits, including two coding tables (T1, T2) and means (8) for selecting a coding table as a function of an information item to be coded;
characterized in that the total number of symbols having a weight equal to 0 is at least equal to 2×2^{p};
in that a first coding table contains 2^{p} symbols having a weight equal to 0; and
in that a second coding table contains 2^{p} other symbols having a weight equal to 0.

9. A coder for coding a binary word, including means for storing at least three coding tables and means for selecting a coding table as a function of an information item to be coded;
characterized in that a first coding table contains 2^{p} symbols having a weight equal to 0;
in that a second coding table contains 2^{p} other symbols having a weight equal to −1;
in that a third coding table contains 2^{p} other symbols having a weight equal to +1; and
in that p and q are chosen so that the number of symbols having a weight equal to 0 or a weight equal to ±1 is at least equal to 3×2^{p}.

10. A coder for coding a word of p bits with a symbol made up of q binary digits, including two coding tables, a coding table being chosen for each binary word to be coded as a function of at least one supplementary information item to be coded;
characterized in that a first coding table contains 2^{p} symbols and a second coding table contains 2^{p} other symbols; and
in that q is greater than or equal to p+1.

11. A decoder for decoding a binary word, characterized in that it includes means (16) for storing at least two decoding tables (T1′, T2′) and means (16, 18) for reproducing an information item as a function of the decoding table used to decode a binary word;
characterized in that a first coding table contains 2^{p} symbols having a weight equal to 0;
in that a second coding table contains 2^{p} other symbols having a weight equal to 0; and
in that the total number of symbols having a weight equal to 0 is at least equal to 2×2^{p};

12. A decoder for decoding a binary word, characterized in that it includes means for storing at least two decoding tables and means for reproducing an information item as a function of the decoding table used to decode a binary word;
characterized in that a first coding table contains 2^{p} symbols having a weight equal to 0;
in that a second coding table contains 2^{p} other symbols having a weight equal to −1;
in that a third coding table contains 2^{p} other symbols having a weight equal to +1; and
in that the total number of symbols having a weight equal to 0 or a weight equal to ±1 is at least equal to 3×2^{p}.

13. A decoder for decoding a binary word, characterized in that it includes means for storing at least two decoding tables and means for reproducing an information item as a function of the decoding table used to decode a binary word;
characterized in that a first coding table contains 2^{p} symbols and a second coding table contains 2^{p} other symbols; and
in that q is greater than or equal to p+1.
